(19) United States
(12) Patent Application Publication
(10) Pub. No.: US 2007/0245927 A1
(43) Pub. Date: Oct. 25, 2007

(54) Security device for the transport and/or the storage of printed values

(75) Inventor: Philippe Besnard, Griselles (FR)

Correspondence Address: YOUNG & THOMPSON, 745 SOUTH 23RD STREET, 2ND FLOOR, ARLINGTON, VA, 22202, US

(73) Assignee: BRINK'S FRANCE, PARIS (FR)

(21) Appl. No.: 11/785,143

(22) Filed: Apr. 16, 2007

(30) Foreign Application Priority Data
Apr. 19, 2006 (FR) 0603460

(51) Int. Cl. C09D 10/00

(52) U.S. Cl. 106/31.93

(57) ABSTRACT

The invention relates to a security device for the transport and/or the storage of printed values (2), comprising a container (1) for receiving those values which is associated with at least one reservoir (3) containing a composition (4) for the degradation of the values, the reservoir being suitable for releasing the degradation composition (4) onto the values (2) under the control of operating means (5), wherein the degradation composition (4) used comprises chlorosulphonic acid in solution in a solvent.

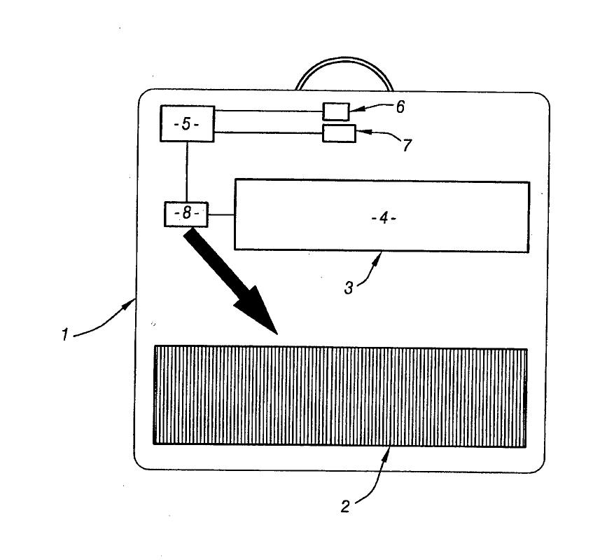

### TECHNICAL FIELD

The present invention relates to a security device for the transport and/or the storage of printed values.

### BACKGROUND TO THE INVENTION

As used in the present description, “printed values” means any document that is printed, especially on paper or plastics material, and that has a fiduciary or non-fiduciary value which may require that the value be rendered secure. In particular, in the sense in which it is used here, the term “printed value” is intended to cover bank-notes, cheque books or other fiduciary values, and also other documents which may be of value, such as contracts, titles, or also identity papers (passports or identity cards, in particular).

The transport and the storage of values of this type are currently effected using containers for receiving those values, for example safes, armour-plated cabinets, secured cases for pedestrian transport, or bank-note dispenser cassettes.

In order to discourage attempts to break into this type of container and in particular to discourage attacks against the vehicles transporting them and their crews, it has been proposed to associate with these containers reservoirs of staining products (generally pigments and/or colorants, carried by a solvent) suitable for dispersing those staining products on the values in the event of an attempt to break in, with the aim of marking the values in order to render them unusable.

However, this solution is not found to be entirely satisfactory, for in many cases it proves difficult, and even impossible, to mark the values indelibly by staining.

Thus, it should first of all be noted that a dispersion on the values to be secured of pigments and/or colorants carried by solvents is not always suitable for carrying out effective staining capable of ensuring the marking sought. In particular, it is found to be ineffective on values having a hydrophobic support, such as, for example, some bank-notes based on polyethylene or polyurethane, or also credit cards or plasticized documents. It may also be found to be inefficient even with values based on less hydrophobic supports, such as values based on cellulose supports, such as paper, depending on the additives added to the support. This is especially the case with many bank-notes based on a paper support which contain agents rendering them impermeable. Those agents, which are intended to ensure the integrity of the values with respect to water and humidity and to prolong their service life, generally render the staining relatively inefficient or even inoperative.

On the other hand, even when effective staining of the values is obtained, this staining cannot in general be regarded as indelible. For there is no way of guaranteeing that processes for washing and chemically treating the values thus stained have not been or will not be discovered, which would then enable these values to be washed and treated in order to put them back into circulation. In fact, the staining obtained often proves to be reversible in as much as products exist which permit the de-staining of the values by washing some staining compositions on bank-notes. Therefore, the protection of values by staining is not completely reliable and it no longer acts as a deterrent.

In order to overcome those difficulties, the Applicant has more recently described improved security devices which, instead of the physical marking of values, permits destruction, or at the very least irreversible modification, by means of a chemical attack. In this context, the use of chlorosulphonic acid, in particular, has been recommended.

Chlorosulphonic acid has in fact proved to be particularly well suited to the rapid destruction of values contained in storage or transport devices where, in particular, it enables printed values, especially bank-notes, to be rendered unusable. In this context, the sulphonic acid permits, in particular, the erasure of the print on printed documents by a phenomenon of solubilization of the inks, which it seems can be explained, inter alia, by a sulphonation of some organic components of the printing inks, especially the binders.

In addition, it has been demonstrated that the gaseous decomposition products of chlorosulphonic acid, containing especially hydrogen chloride (HCl), enable paper-based supports to be de-structured, rendering them extremely fragile and brittle, these supports crumbling in the hand after contact with the decomposition products, which renders them unusable.

To be more precise, in the secured storage or transport devices where it is used, chlorosulphonic acid is decomposed in accordance with the following reaction:
HClSO₃+H₂O=>HCl+H₂SO₄

Since HCl is gaseous under normal conditions, the reaction brings about the formation of a volume of gas and excess pressure inside the container of the device. The reaction is also exothermic, so that it brings about an increase in temperature in the pressurized container. Under these conditions, the decomposition gases released circulate freely in the container, thus ensuring intimate and efficient contact with all of the values and ensuring a particularly efficient destruction of the values to be secured.

Despite these various advantages, the use of chlorosulphonic acid is found to be problematic in practice, precisely because of the gaseous decomposition products which it generates.

For these decomposition products, which are particularly virulent, have a negative impact on the environment, in particular HCl, which is regarded as toxic at very low contents. Therefore, it is necessary to neutralize efficiently the gases produced. Such neutralization in fact proves to be very difficult to carry out, especially bearing in mind the speed at which the gases are formed, which renders inefficient, for example, conventional adsorbents, such as activated carbon or aluminium oxide.

Furthermore, the generation of decomposition gases brings about excess pressure inside the container for storing the values, and this poses problems in ensuring efficient sealing of the container used.

### SUMMARY OF THE INVENTION

An object of the present invention is to provide a device for securing printed values which is efficient, that is to say, which enables printed values to be rendered unusable in a reliable, rapid and definitive manner but which avoids the above-mentioned disadvantages associated with the decomposition of chlorosulphonic acid.

To that end, according to a first aspect, the invention provides a security device for the transport and/or storage of printed values, comprising a container for receiving those values which is associated with at least one reservoir containing a composition for the degradation of the values, the reservoir being suitable for releasing the degradation composition onto the values under the control of operating means, wherein the degradation composition comprises chlorosulphonic acid, in solution in a solvent (S) of that acid.

Advantageously, the solvent (S) which solubilizes the chlorosulphonic acid in the degradation composition is a chlorinated or fluorinated, and preferably chlorinated, organic solvent. Chlorinated solvents particularly suitable as the solvent (S) are chloro-1-butane, chloro-2-propane, 1,2,3-trichloropropane, dichloromethane, chlorohexane, trichloroethylene, and also mixtures of those solvents.

The inventors have now demonstrated that the solubilization of chlorosulphonic acid in a solvent, especially of the above-mentioned type, inhibits the phenomenon of decomposition of that acid in HCl and H₂SO₄, as conventionally observed in the absence of such a solvent.

Thus, in the device of the invention, the chlorosulphonic acid in solution in the solvent (S) plays its conventional role referred to as “solubilization” of inks, as demonstrated especially in FR 04 06603, without at the same time leading to the phenomenon of gaseous decomposition which is exploited, for example, in the devices described in FR 04 10456.

To be more precise, in the device of the invention, the chlorosulphonic acid enables the pigments to be separated from the inks deposited on printed values, so that simple treatment with water (immersion in a water bath or washing) or even simply rubbing the thus-modified surface of the values leads to an entrainment of the pigments and therefore to the erasure of the print, thus rendering the values unusable. If necessary, the chlorosulphonic acid also permits an attack on the metal portions which may be present on the values, such as holograms, or the security thread, in the specific case of bank-notes. These reactions are very rapid and are generally complete after a time lapse of the order of one second at the very most, and generally much less (typically of the order of one hundredth of a millisecond, or even less).

The printing inks deposited (typically by rotogravure or offset printing) on the printed values secured in accordance with the invention generally comprise organic or mineral pigments intimately mixed with a binder.

The organic or mineral pigments used are generally selected from the following products:
carbon black;
chrome oxide green;
titanium dioxide;
phthalocyanine blue;
azo compound;
green 7, 36;
violet 23;
varnishes fluorescent under ultraviolet radiation.

The binder, which is also called a vehicle in the case of offset printing, is for its part generally selected from the following products:
non-crystalline oligomeric or polymeric hard resins that are solid at ambient temperature and soluble in weak solvents. These are especially phenol resins modified by rosin and fluid constituents (vegetable oils containing at least 20% soya oil, petroleum distillates, alkyd resins);
the vegetable oils of triglyceride esters of unsaturated fatty acids;
drying oils, such as linseed oil;
rosins extracted from conifers (pine) or obtained from gum, wood or tall oil and their derivatives;
plastics polymer varnishes;
gelatin.

Without wishing to be bound to any particular theory, it is assumed that, in the context of the present invention, chlorosulphonic acid dissolved in a solvent medium has a sulphonation action on some of the organic compounds of the ink, especially the binders, which would destroy the cohesion of the ink in the print. In some cases, this reaction could also involve other organic compounds present at the surface of the printed values.

According to one particular aspect, the invention also relates to this use of a solution of chlorosulphonic acid in a solvent of the said acid, preferably an organic solvent of the above-mentioned type, in a security device for the transport and/or the storage of printed values, in order to degrade at least partially the printing ink of the values in the event of a break-in or an attempt at break-in, with a view to rendering the values unusable.

Advantageously, the degradation composition used in the device of the invention comprises, in addition to the chlorosulphonic acid and the solvent (S), one or more pigments or colorants for staining the values. In this context, compounds that are not susceptible to degradation by chlorosulphonic acid and that are preferably soluble or dispersible in the solvent (S) are used. Advantageously, it is typically possible to use one or more pigments or colorants selected from the following compounds:
copper phthalocyanines;
carbon black;
ferric oxides;
titanium oxides;
zinc pigments;
iron blues;
cadmium pigments.

This addition of pigments or colorants opens up, in particular, the possibility of marking secured values after a break-in, this especially permitting the marking) of the batches to be secured, which is routinely required in the field of the transport of money.

Furthermore, the addition of pigments or colorants above all permits the further-enhanced securing of the values by preventing definitively any possibility of re-using the values treated. For, by using chlorosulphonic acid and colorants or pigments jointly, there is obtained at the same time (i) a separation of the ink from the support of the values and (ii) a staining of the surface. The staining obtained renders the values unusable in their current state, thus obliging the authors of a break-in, who would like to re-use the values, to wash them beforehand. Such a de-staining treatment inevitably leads to an at least partial, if not total, elimination of the print, again rendering the values unusable.

A particularly suitable degradation composition in the context of the present invention typically comprises:
from 10% to 80% by volume (for example, from 15% to 50%, especially from 15% to 25%, and preferably of the order of 20% by volume) of chlorosulphonic acid;
from 10% to 80% by volume of at least one chlorinated organic solvent, this chlorinated solvent advantageously being selected from chloro-1-butane, chloro-2-propane, 1,2,3-trichloropropane, dichloromethane, chlorohexane, trichloroethylene, and mixtures of those solvents;
from 0.5 to 2% by mass, relative to the mass of the chlorinated solvent, of at least one pigment or colorant, preferably of the above-mentioned type.

The compositions of this type, which, to the Applicant's knowledge, have never been described, constitute according to a further aspect yet another particular subject of the present invention.

Irrespective of the exact nature of the degradation composition employed, the security device of the invention using it may also comprise one or more of the following features:
the means for operating the device are suitable for triggering the operation of a pyrotechnic trigger for dispersing the product on the values, which trigger is associated with the reservoir;
the device is an automatic teller machine (ATM), a container for transporting money or a container for storing money;
the printed values comprise a paper-based or plastics-based support.

### BRIEF DESCRIPTION OF THE DRAWING

The invention will be even further illustrated by the following description which is given purely by way of example and with reference to the single appended FIGURE which is a schematic diagram showing schematically the general structure of a device according to the invention.

### DESCRIPTION OF PREFERRED EMBODIMENTS

To be more precise, the single appended FIGURE shows a security device for the transport and/or the storage of values which comprises a container for receiving those values 1 which is in the form, for example, of a secured case or a bank-note dispenser cassette. The container 1 may also be formed by a safe, an armour-plated cabinet etc. located in a vehicle, a building, etc. The container 1 contains the printed values 2 to be secured, which are typically bank-notes, titles, cheques, credit cards, contracts, or also identity cards or passports.

The container 1 is associated with at least one reservoir 3 containing a degradation composition 4 based on chlorosulphonic acid in solution in a solvent which is typically selected from chloro-1-butane, chloro-2-propane, 1,2,3-trichloropropane, dichloromethane, chlorohexane and trichloroethylene, a very specially suitable solvent being dichloromethane. Trichloroethylene is also found to be efficient in the context of the invention but that solvent is of lesser interest, bearing in mind its toxicity. As a general rule, the composition 4 also contains a colorant or a pigment for staining the values. The degradation composition 4 is capable of being released in the case of particular events, especially in the case of a break-in or an attempt at break-in, under the control of operating means 5.

The operating means 5 are connected to means for detecting a triggering event, typically a contact 6 for the unauthorized opening of the case or also means 7 for monitoring the integrity thereof in order to enable the operating means 5 to trigger the functioning of means 8 for releasing the degradation composition 4 onto the values 2 in the event of an attempt at break-in. Other operating means are of course possible, such as, for example, means for detecting the reception or non-reception of a security signal, as is known.

The release means 8 may comprise, for example, a pyrotechnic trigger associated with the reservoir 3. Such a pyrotechnic trigger, which is based on an explosive, generally enables the reservoir 3 to be broken and the degradation composition to be dispersed properly on the values at the same time. If necessary, it also enables any packaging on the values to be broken, thus permitting optimum sprinkling.

The dispersion, thus obtained, of the composition 4 on the values leads to a degradation of the cohesion of the print on the support, rendering this print fragile and likely to be damaged completely or partially. The time necessary to bring about this embrittlement is generally of the order of a few seconds at most.

When the treatment is complete, the print on the printed values may in some cases disappear at least in part, which renders them unusable.

In other, more frequent, cases, embrittlement is obtained such that, although the print remains on the values, it is rendered completely or partially erasable simply by rubbing or by washing with water, which in that case renders the values practically unusable, the embrittlement of the ink being very easy to detect. In this hypothetical case, the presence of pigments or colorants in the composition 4 completes the securing process. For these pigments or colorants lead to the values' being stained, thus rendering them detectable. In order to be re-used, the values would have to undergo a de-staining treatment, which would then lead to the erasure of the print.

Therefore, in the event of a break-in, the security device enables the values to be modified irreversibly, consequently rendering them unusable and without value, which is a deterrent to any attempt to break into the device.

1. Security device for the transport and/or the storage of printed values, comprising a container for receiving the printed values which is associated with at least one reservoir containing a composition for the degradation of the values, the reservoir being suitable for releasing the degradation composition onto the values under the control of operating means, wherein the degradation composition used comprises chlorosulphonic acid in solution in a solvent of the said acid.

2. Device according to claim 1, wherein the solvent is a chlorinated solvent selected from chloro-1-butane, chloro-2-propane, 1,2,3-trichloropropane, dichloromethane, chlorohexane, trichloroethylene, and mixtures of those solvents.

3. Device according to claim 1, wherein the degradation composition also comprises at least one pigment or colorant for staining the values.

4. Device according to claim 3, wherein the degradation composition comprises:
from 10% to 80% by volume of chlorosulphonic acid;
from 10% to 80% by volume of at least one chlorinated organic solvent; and
from 0.5 to 2% by mass, relative to the mass of the chlorinated solvent, of at least one pigment or colorant.

5. Device according to claim 1, wherein the operating means are suitable for triggering the operation of a pyrotechnic trigger for dispersing the product on the values, which trigger is associated with the reservoir.

6. Device according to claim 1, wherein it is an automatic teller machine (ATM), a container for transporting money, or a container for storing money.

7. Process for securing the transport and/or the storage of printed values, comprising the steps of:
introducing the printed values into a security device comprising a container for receiving the printed values and a reservoir containing a degradation composition comprising a solution of chlorosulphonic acid in a solvent of the said acid;
releasing the degradation composition onto the values for degrading at least partially the printing ink of the printed values in the event of a break-in or an attempt at break-in.

8. Degradation composition for a security device according to claim 1, comprising:
from 10% to 80% by volume of chlorosulphonic acid;
from 10% to 80% by volume of at least one chlorinated organic solvent; and
from 0.5 to 2% by mass, relative to the mass of the chlorinated solvent, of at least one pigment or colorant.

9. Composition according to claim 8, wherein the chlorinated organic solvent is selected from chloro-1-butane, chloro-2-propane, 1,2,3-trichloropropane, dichloromethane, chlorohexane, trichloroethylene, and mixtures of those solvents.
